(19) United States
(12) Patent Application Publication
(10) Pub. No.: US 2006/0018791 A1
(43) Pub. Date: Jan. 26, 2006

(54) Storage system and method of operating thereof

(76) Inventors: William David Riling, Franklin, TN (US); Paul Wayne Pollock, Nashville, TN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/183,237

(22) Filed: Jul. 18, 2005

Related U.S. Application Data
(60) Provisional application No. 60/588,339, filed on Jul. 16, 2004.

(51) Int. Cl. G01N 35/00

(52) U.S. Cl. 422/63

(57) ABSTRACT

A storage system that may be configured to make efficient use of available floor space in a laboratory. The storage system includes a primary storage module and one or more auxiliary storage modules positioned adjacent thereto. Stored items may be transferred between the storage modules using transfer mechanisms that are integrated into the modules. Also, a method of storage that may be implemented using such a storage system.

### CROSS-REFERENCE TO RELATED APPLICATIONS

This application claims priority from the provisional U.S. patent application entitled, “Method and Apparatus for Configuring a Storage Cell,” filed Jul. 16, 2004 and having Ser. No. 60/588,339, the disclosure of which is hereby incorporated by reference in its entirety.

### FIELD OF THE INVENTION

The present invention relates generally to storage systems. The present invention also relates generally to storage methods that may be implemented using storage systems.

### BACKGROUND OF THE INVENTION

Drug discovery and many of the methods used in processes associated with drug discovery are slowly becoming automated. As a result of this increase in automation, drugs often get introduced into the marketplace faster. However, the increase in automation has created at least two issues in laboratories throughout the world.

The first issue is that space is now at an all-time premium. Therefore, the ability to expand storage and/or to have the storage conform to the available lab space would be highly desirable, as would be units that can be expanded at a later date. The second issue is that, with the increasing amount of automation in drug discovery, more and more experiments are being run in a much shorter period of time. This has resulted in a proliferation of sample-holding plates that require either short-term or long-term shortage and incubation for temporal analysis.

One currently-available method used to reduce the time associated with drug discovery involves the use of machines that automatically perform protein crystallography and then collect the related data. Currently, these machines are limited in the types of configurations available.

Prior art solutions to the above-mentioned space constraint problem involved interconnecting two storage cells via carousels or conveyor belts. However, use of carousels configured to receive a stored plate from a first storage cell, to rotate the plate and to hand the plate off to a second storage cell have relatively large footprints. Therefore, potential storage positions are sacrificed.

Further, carousels must maintain environmental conditions that are similar to those found in the storage cells to which the carousels connect. However, the geometry of carousels limits the ability to regulate the environmental conditions therein unless the carousels are attached linearly to the storage cells. Therefore, the use of carousels limits the configuration of storage cells to linear arrangements.

The use of conveyor belts, like the use of carousels, restricts configurations to being linear. Also, a plate must be precisely located by the conveyor belt to affect a transfer from one storage cell to another. Further, when using conveyor belts, a large amount of potential storage space is wasted to accommodate the presence of the conveyor belt. Even further, the use of conveyor belts makes it difficult and costly to maintain environmental conditions similar to those found in the storage cells during the conveyance operation.

At least in view of the above-discussed factors, it would be desirable for novel storage systems and methods to be developed that would allow for the addition of portable modular cells to existing systems in almost any geometric configuration.

### SUMMARY OF THE INVENTION

The foregoing needs are met, to a great extent, by the present invention, wherein in one aspect thereof, a transfer mechanism is provided. The transfer mechanism includes a supporting section configured to be movable between a first position inside of a first labware storage module and a second position outside of the first labware storage module. The supporting section is further configured to receive a piece of labware from a first mobile device in the first labware storage module when in the first position. In addition, the supporting section is also configured to avail the piece of labware to transfer to a second mobile device in a second labware storage module when in the second position. The transfer mechanism also includes an actuator operably connected to the supporting section and configured to move the supporting section between the first position and the second position.

According to another embodiment of the present invention, a storage system is provided. The storage system includes a primary storage module configured to store an item. The storage system also includes a first auxiliary storage module positioned adjacent to the primary storage module and configured to store the item. The storage system further includes a first transfer mechanism integrated into the primary storage module and configured to transfer the item from the primary storage module to the first auxiliary storage module.

According to yet another embodiment of the present invention, a method of storage is provided. The method includes introducing an item into a primary storage module. The method also includes transferring the item to a first auxiliary storage module located adjacent to the primary storage module using a transfer mechanism integrated in the primary storage module.

According to still another embodiment of the present invention, another transfer mechanism is provided. The transfer mechanism includes supporting means for supporting a piece of labware. The supporting means is movable between a first position inside of a first labware storage module and a second position outside of the first labware storage module. The supporting means is configured to receive the piece of labware from a first mobile device when in the first position and to avail the piece of labware to transfer to a second mobile device when in the second position. The transfer mechanism also includes moving means connected to the supporting means and configured to move the supporting means between the first position and the second position.

### BRIEF DESCRIPTION OF THE DRAWINGS

FIG. 1 is a perspective view of a storage system according to an embodiment of the present invention.

FIG. 2 is a perspective view of the interior of a portion of a storage module according to an embodiment of the present invention.

FIG. 3 is a perspective view of an interior region of the primary storage module illustrated in FIG. 1 according to certain embodiments of the present invention.

FIG. 4 is another perspective view of the interior region of the primary storage module illustrated in FIG. 1.

FIG. 5 is a perspective view of a portion of a laboratory positioning robot that may be used according to certain embodiments of the present invention, wherein a spatula, used for supporting the labware to be stored, is in an extended position.

FIG. 6 is a perspective view of the portion of the laboratory positioning robot illustrated in FIG. 5, wherein a spatula, used for supporting the labware to be stored, is in a retracted position.

FIG. 7 is a perspective view of two prongs, a spatula and a laboratory plate during a handoff operation from a robot to a transfer mechanism, or vice versa.

### DETAILED DESCRIPTION

The invention will now be described with reference to the drawing figures, in which like reference numerals refer to like parts throughout.

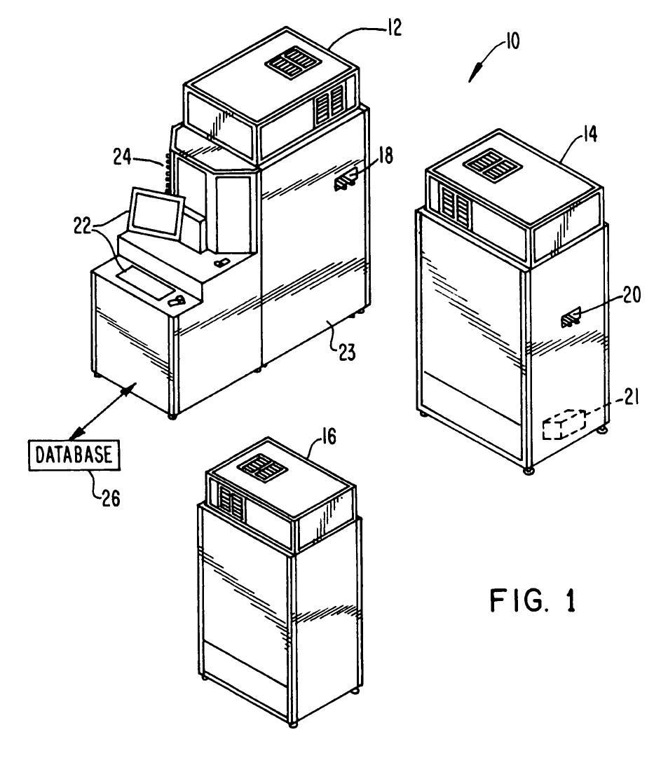

FIG. 1 is a perspective view of a storage system 10 according to an embodiment of the present invention. The storage system 10 includes a primary storage module 12 configured to store an item, such as a piece of labware (i.e., a plate, a vial, a tube, a bottle, a lab-on-a-chip device, etc.). The storage system 10 also includes a first auxiliary storage module 14 that may be either positioned adjacent to the primary storage module 12 or that may be disconnected from the primary storage module 12 and positioned at a remote location. The first auxiliary storage module 14 is also configured to store the above-mentioned item.

The storage system 10 further includes a second auxiliary storage module 16 that may be positioned adjacent to either the first auxiliary storage module 14 or to the primary storage module 12 when the first auxiliary storage module 14 is not adjacent to the primary storage module 12. Also, the second auxiliary storage module 16 may be disconnected from the primary storage module 12 and/or the first auxiliary storage module 14 and positioned at a remote location.

Also as illustrated in FIG. 1 is a transfer mechanism 18 that is integrated into the primary storage module 12. The transfer mechanism 18 is typically configured to transfer the above-mentioned item (e.g., a piece of labware) from the primary storage module 12 to either the first auxiliary storage module 14 or any other storage module that is adjacent or linked to the primary storage module 12 at any given time.

Also illustrated in FIG. 1 is a second transfer mechanism 20 that is integrated into the first auxiliary storage module 14. The second transfer mechanism 20 is typically configured to transfer the above-mentioned item from the first auxiliary storage module 14 to either the second auxiliary storage module 16 or any other storage module that is positioned adjacent to the first auxiliary storage module 14 at a given time.

Typically, when two or more auxiliary storage modules are connected to the primary storage module 12, either directly or indirectly, each module, with the possible exception of the last module in a chain, includes one or more transfer mechanisms that are similar to the first transfer mechanism 18 and second transfer mechanism 20. As such, a large number of auxiliary storage modules may be operably connected to the primary storage module 12.

The first auxiliary storage module 14 and the second auxiliary storage module 16 may be chosen to have different geometries. For example, the first auxiliary storage module 14 may be longer and/or wider and/or taller than the second auxiliary storage module 16, or vice-versa. Therefore, when a plurality of auxiliary storage modules are connected to the primary storage module 12 illustrated in FIG. 1, the geometries of the auxiliary storage modules may be selected so as to fill up substantially all available floor space in a designated portion of a laboratory.

Typically, the primary storage module 12 and any auxiliary storage modules in the storage system 10 are configured to store laboratory samples under specified environmental conditions (i.e., controlled temperature, humidity, etc.). As such, the first auxiliary storage module 14 illustrated in FIG. 1 is configured to maintain environmental conditions that are substantially identical to those found in the primary storage module 12, even when detached from the primary storage module 12, so long as experimental samples are stored in the first auxiliary storage module 14. The second auxiliary storage module 16 illustrated in FIG. 1 and any other auxiliary storage module that may be included in the storage system 10 are also typically configured to maintain environmental conditions that are substantially identical to those found in the primary storage module 12 whether or not they are connected to the primary storage module 12, so long as samples are stored therein.

As illustrated in FIG. 1, the primary storage module 12 includes a primary controller 22 that takes the form of a computer operably connected to the primary storage module 12. Typically, the primary controller 22 is configured to control the operation of at least the first transfer mechanism 18 in the primary storage module 12. The primary controller 22 may also be configured to locate the above-mentioned item in either the primary storage module 12 or any auxiliary storage modules connected thereto. Further, the primary controller 22 is typically configured to effectuate retrieval of the item from any storage module in the system 10 upon request from a user.

As illustrated in FIG. 1, a secondary controller 21 is operably connected to the first auxiliary storage module 14. Also, additional auxiliary storage modules included in the storage system 10 typically have individual controllers operably connected thereto. The secondary controller 21 and any additional controllers are typically configured to locate an item when the item is being stored in the auxiliary storage module to which the controller in question is operably connected. For example, when the primary controller 22 attempts to effectuate the retrieval of an item upon receiving a request from a user, the primary controller 22 typically first determines whether the primary storage module 12 is currently storing the item. Then, if the item is not stored in the primary storage module 12, the primary controller 22 typically interacts (e.g., exchanges electronic signals) with the secondary controller in the first auxiliary storage module 14 and/or other controllers in other auxiliary storage modules to determine the location of the item in the storage system 10. At that point, the primary controller 22 generally operates in conjunction with controllers in the auxiliary storage modules to transfer the item back to the primary storage module 12. A user may then retrieve the item from an Input/Output system 24 (e.g., a door) included in the primary storage module 12, as illustrated in FIG. 1.

In order to expedite the location and retrieval of an item in the storage system 10, a database 26 is operably connected to the primary storage module 12. However, according to other embodiments of the present invention, the database 26 may be operably connected to any or all of the storage modules in the storage system 10. Typically, the database 26 is configured to store data related to where an item is located in the storage system 10 at a specified time.

The database 26 is commonly configured to receive signals from either the primary controller 22 in the primary storage module 12 or from any other controller in any of the auxiliary storage modules operably connected to the primary storage module 12. These signals generally inform the database 26 either that an item has been moved to a new position in the storage system 10 or may simply periodically update the database 26 regarding the location of some or all items storage in the storage system 10.

According to certain embodiments of the present invention, the primary storage module 12 includes an analysis region 28 that is configured to analyze an item in the storage system 10 in some manner. For example, the analysis region 28 may take the form of an imager configured to take a image of an item in the storage system 10. Because the analysis region 28 illustrated in FIG. 1 is located within the primary storage module 12, an item stored anywhere in the storage system 10 may be analyzed in the analysis region 28 without ever leaving the environmental conditions that are preserved throughout all of the storage modules in the storage system 10.

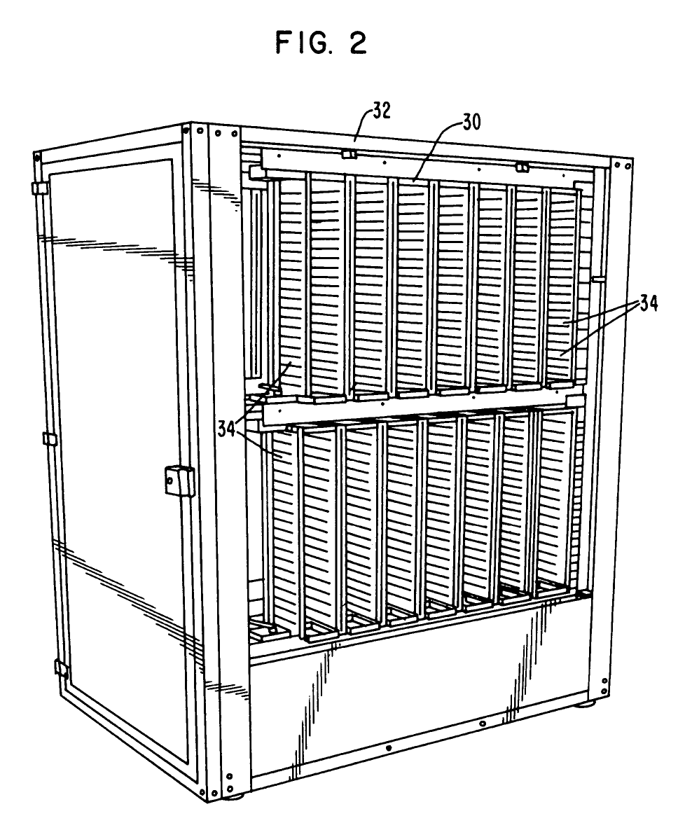

FIG. 2 is a perspective view of the interior of a portion of a storage module 32 according to an embodiment of the present invention. The portion of the storage module 32 may be incorporated into the primary storage module 12 or any auxiliary storage module in the storage system 10. As illustrated in FIG. 2, the primary storage module 12 includes a plurality of labware storage hotels 30. Once introduced into the storage system 10 illustrated in FIG. 1, an item is typically stored in one of the slots 34 of a labware storage hotel 30. Typically, a labware positioning robot is used to place an item into a slot 34 and to move items between any of the slots 34 illustrated in FIG. 2. The labware positioning robot may take the form of any mechanical device that can move a piece of labware in three-dimensional space between the slots 34 of one or more labware storage hotels 30 in a storage module 32.

In the storage system 10 illustrated in FIG. 1, the robot in the primary storage module 12 is configured to be operated (i.e., controlled) by the primary controller 22. Also, the robots in the first auxiliary storage module 14 and the second auxiliary storage module 16 are configured to be operated by the controllers operably connected to each of those modules, respectively. However, according to certain embodiments of the present invention, the primary controller 22 is configured to control all robots in the storage system 10.

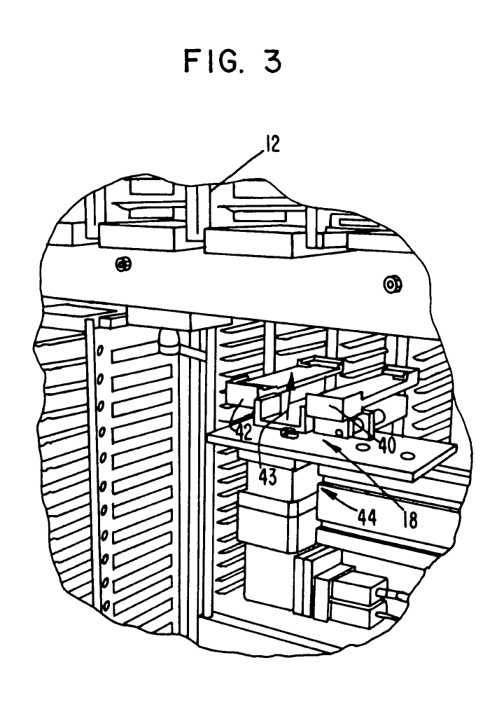

FIG. 3 is a perspective view of an interior region of the primary storage module 12 illustrated in FIG. 1 according to certain embodiments of the present invention. Interior regions similar or identical to the interior region illustrated in FIG. 3 may be included, for example, in any of the auxiliary storage modules in the storage system 10 illustrated in FIG. 1.

In FIG. 3, the first transfer mechanism 18 in the primary storage module 12 is illustrated in a first position that does not extend beyond the interior of the primary storage module 12. As illustrated in FIG. 3, the first transfer mechanism 18 includes a supporting section 38 that takes the form of a fork having a first prong 40 and a second prong 42.

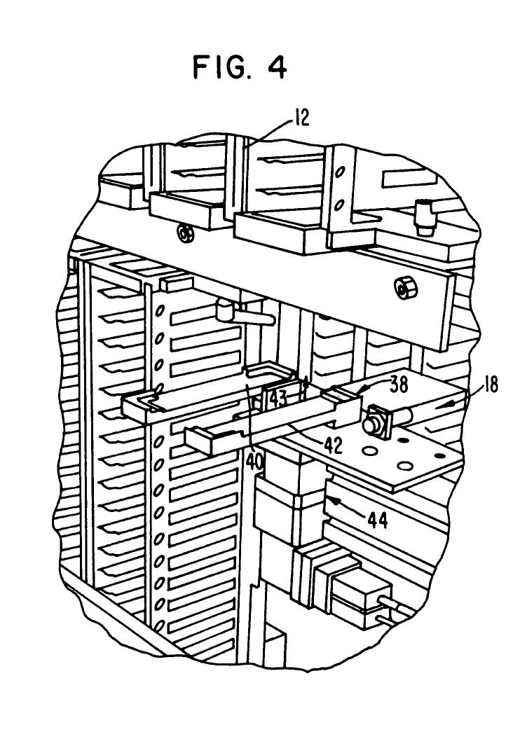

FIG. 4 is another perspective view of the interior region of the primary storage module 12 illustrated in FIG. 1. In FIG. 4, the first transfer mechanism 18 is in a second position that extends beyond the interior of the primary storage module 12. In other words, the first transfer mechanism 18 illustrated in FIG. 3 extends beyond the casing 23 of the primary storage module 12 illustrated in FIG. 1.

As illustrated in FIGS. 3 and 4, an actuator 44, which often takes the form of a mechanical motor, is operably connected to the supporting section 38 and is configured to move the supporting section 38 between the first position illustrated in FIG. 3 and the second position illustrated in FIG. 4. According to certain embodiments of the present invention, the actuator 44 is configured to rotate the supporting section 38 about an axis (e.g., the central axis of rotation 43 in FIGS. 3 and 4) when moving the supporting section 38 between the first position and the second position. However, according to other embodiments of the present invention, the supporting section 38 may be translated between the first and second positions or may undergo some other form of motion.

As discussed previously, the storage modules in the storage system 10 illustrate in FIG. 1 typically each include a labware positioning system (e.g., a robot) that can move labware around within a given module. According to certain embodiments of the present invention, the supporting section 38 illustrated in FIGS. 3 and 4 is configured to receive a plate from a robot configured to position experimental sample plates in a storage hotel. In these embodiments, a robot in the primary storage module 12 may retrieve a plate or other piece of labware from within the primary storage module 12 and may place the piece of labware onto the forks 40,42 of the supporting section 38. In FIGS. 3 and 4, the supporting section 38 is configured to receive a piece of labware from a first mobile device (e.g., a robot) in the primary storage module 12 when in the first position that does not extend beyond the primary storage module 12 (see FIG. 3).

Once the supporting section 38 is in the second position that extends beyond the primary storage module 12 (see FIG. 4), the supporting section 38 is configured to avail the piece of labware supported thereby to transfer to a second mobile device in an auxiliary storage module 14 (i.e., a labware positioning robot in an auxiliary storage module).

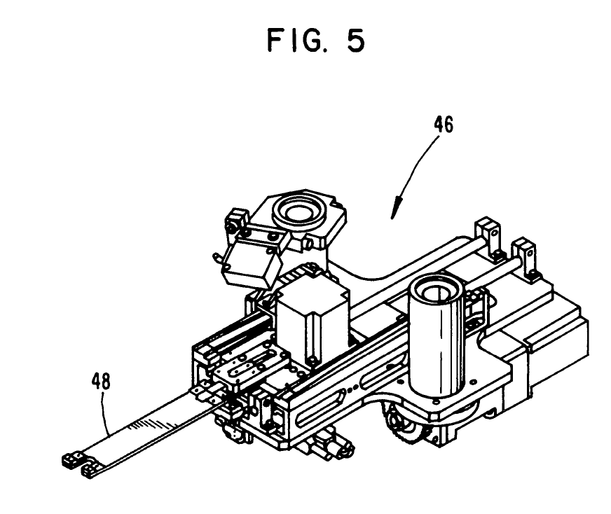

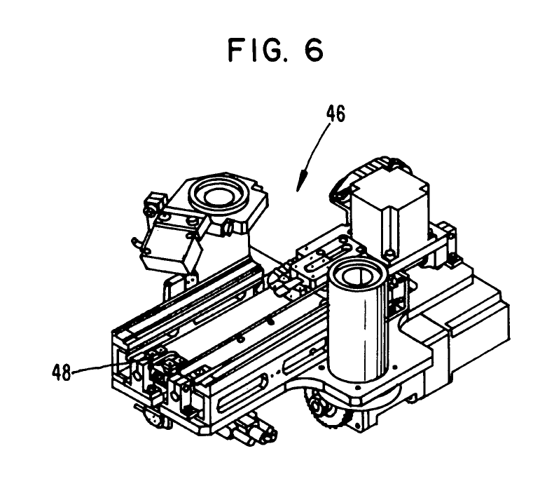

FIGS. 5 and 6 are perspective views of a portion of a laboratory positioning robot 46 that may be used according to certain embodiments of the present invention. In FIG. 5, a spatula 48 included in the portion 46 and used for supporting the labware to be stored is illustrated in an extended position and in FIG. 6 the spatula is illustrated in a retracted position.

In FIG. 5, the spatula 48 protrudes from the portion 46. In operation (i.e., when a piece of labware is being moved), the spatula 48 typically has a piece of labware on top thereof. When no piece of labware is being supported by the spatula 48, the spatula 48 retracts into the portion 46, as illustrated in FIG. 6.

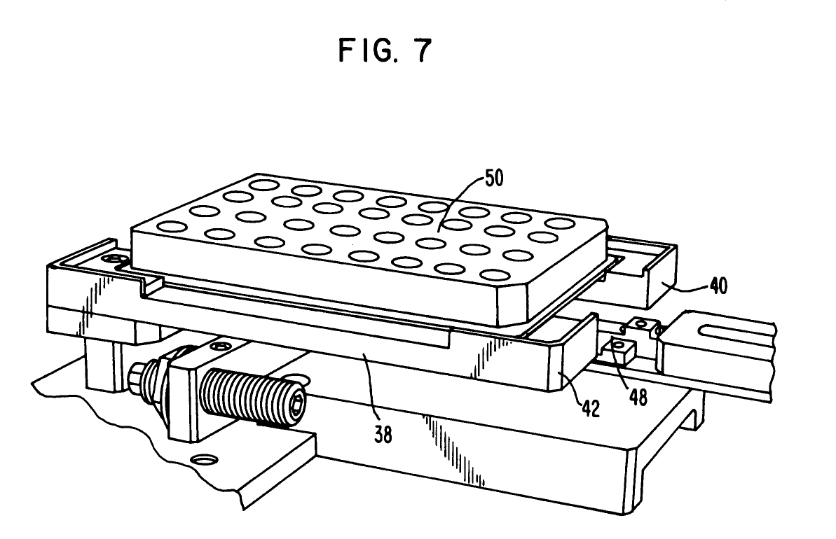

FIG. 7 is a perspective view of two prongs 40, 42, a spatula 48 and a laboratory plate 50 during a handoff operation from a robot to a transfer mechanism, or vice versa. As illustrated in FIG. 7, the spatula 48 carrying the laboratory plate 50 is configured to be able to travel between the first prong 40 and the second prong 42 of the supporting section 38 illustrated in FIGS. 3 and 4. Therefore, when the spatula 48 travels from a position above the prongs 40, 42 to a position below the prongs 40, 42, the laboratory plate 50 is deposited onto the prongs 40, 42 of the supporting section 38. Pursuant to this transfer, the supporting section 38 may move to a position that extends beyond the primary storage module 12 and that allows another spatula from a laboratory positioning robot in an auxiliary storage module to pick the laboratory plate 50 up from the supporting section 38. Then, the laboratory plate 50 may be stored in a storage hotel of an auxiliary storage module.

In operation, the storage system 10 illustrated in FIG. 1 may be used to store one or move piece of labware. Typically, when storing labware in the storage system 10, the labware is introduced into the primary storage module 12. For example, a laboratory plate may be introduced through the input/output system 24 of the primary storage module 12. Then, the plate is transferred to a first auxiliary storage module that is located adjacent to the primary storage module. This transferring step typically includes using a transfer mechanism integrated in the primary storage module, such as the first transfer mechanism 18 illustrated in FIGS. 3 and 4.

According to certain embodiments of the present invention, the plate or, more generally, the item, may be transferred to a second auxiliary storage module that is located adjacent to the first auxiliary storage module. Typically, a second transfer mechanism that is integrated into the first auxiliary storage module is used.

In some embodiments of the present invention, the location of the item in the primary storage module and the first auxiliary storage module is determined from the primary storage module. Retrieval of the item may be effectuated upon receiving a request from a user. The primary controller 22 is used in combination with any of a plurality of other controllers (e.g., secondary controller 21) in the storage system 10 and/or the database 26 to determine the position of a piece of labware in the storage system 10 and execute the retrieval. This retrieval often requires controllers in auxiliary storage modules to control robots therein such that the robots transfer the piece of labware to each other and, ultimately, to the primary storage module 12 using transfer mechanisms.

In certain laboratory situations, it is desirable to detach and move the first auxiliary storage module away from the primary storage module. For example, when only a small amount of storage space is available in a first area in a lab and a large amount of space is available in a second area, a plurality of items may be placed into an auxiliary storage module at the first area and the auxiliary storage module may then be moved to the second area, usually after a second auxiliary storage module is positioned adjacent to the primary storage module. In such instances, additional items may be transferred to the second auxiliary storage module using the transfer mechanism integrated into the primary storage module

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A transfer mechanism, comprising:
a supporting section configured to be movable between a first position inside of a first labware storage module and a second position outside of the first labware storage module, wherein the supporting section is further configured to receive a piece of labware from a first mobile device in the first labware storage module when in the first position and to avail the piece of labware to transfer to a second mobile device in a second labware storage module when in the second position; and
an actuator operably connected to the supporting section and configured to move the supporting section between the first position and the second position.

2. The transfer mechanism of claim 1, wherein the supporting section comprises:
a first prong; and
a second prong adjacent to the first prong.

3. The transfer mechanism of claim 2, wherein the first prong and the second prong are positioned so as to allow a third prong to travel therebetween.

4. The transfer mechanism of claim 1, wherein the actuator is configured to rotate the supporting section about an axis when moving the supporting section between the first position and the second position.

5. The transfer mechanism of claim 1, wherein the supporting section is configured to receive a plate from a robotic plate mover configured to position plates in a storage hotel.

6. A storage system, comprising:
a primary storage module configured to store an item;
a first auxiliary storage module positioned adjacent to the primary storage module and configured to store the item; and
a first transfer mechanism integrated into the primary storage module and configured to transfer the item from the primary storage module to the first auxiliary storage module.

7. The storage system of claim 6, wherein the first auxiliary storage module is configured to maintain environmental conditions that are substantially identical to those found in the primary storage module when the first auxiliary storage module is detached from the primary storage module.

8. The storage system of claim 6, further comprising:
a second auxiliary storage module positioned adjacent to the first auxiliary storage module; and
a second transfer mechanism integrated into the first auxiliary storage module and configured to transfer the item from the first auxiliary storage module to the second auxiliary storage module.

9. The storage system of claim 8, wherein the first auxiliary storage module and the second auxiliary storage module have different geometries.

10. The storage system of claim 6, wherein the primary storage module comprises:
a primary controller operably connected to the primary storage module and configured to control operation of the transfer mechanism.

11. The storage mechanism of claim 10, wherein the primary controller is further configured locate the item in the primary storage module and in the first auxiliary storage module and to effectuate retrieval of the item upon request.

12. The storage system of claim 10, wherein the auxiliary storage module comprises:
a secondary controller operably connected to the first auxiliary storage module and configured to locate the item when the item is in the first auxiliary storage module.

13. The storage system of claim 6, wherein the primary storage module comprises:
an analysis region configured to analyze the item.

14. The storage system of claim 6, wherein the primary storage module comprises a labware storage hotel.

15. The storage system of claim 6, further comprising:
a database operably connected to the primary storage module and configured to store data related to where the item is located at a specified time.

16. A method of storage, the method comprising:
introducing an item into a primary storage module; and
transferring the item to a first auxiliary storage module located adjacent to the primary storage module using a transfer mechanism integrated in the primary storage module.

17. The method of claim 16, further comprising:
transferring the item to a second auxiliary storage module located adjacent to the first auxiliary storage module using a second transfer mechanism integrated into the first auxiliary storage module.

18. The method of claim 16, further comprising:
determining, from the primary storage module, where the item is located in the primary storage module and the first auxiliary storage module; and
effectuating retrieval of the item to a user upon request.

19. The method of claim 16, further comprising:
moving the first auxiliary storage module away from the primary storage module;
positioning a second auxiliary storage module adjacent to the primary storage module;
transferring the item to the second auxiliary storage module using the transfer mechanism integrated into the primary storage module.

20. A transfer mechanism, comprising:
supporting means for supporting a piece of labware, the supporting means being movable between a first position inside of a first labware storage module and a second position outside of the first labware storage module, wherein the supporting means is configured to receive the piece of labware from a first mobile device when in the first position and to avail the piece of labware to transfer to a second mobile device when in the second position; and
moving means connected to the supporting means and configured to move the supporting means between the first position and the second position.
